(19) United States
(12) Patent Application Publication
(10) Pub. No.: US 2006/0284617 A1
(43) Pub. Date: Dec. 21, 2006

(54) Model-based predictive diagnostic tool for primary and secondary batteries

(76) Inventors: James D. Kozlowski, Bellefonte, PA (US); Carl S. Byington, Boalsburg, PA (US); Amulya K. Garga, State College, PA (US); Thomas Cawley, Altoona, PA (US); Matthew J. Watson, Altoona, PA (US); Todd A. Hay, State College, PA (US)

Correspondence Address: GIFFORD, KRASS, GROH, SPRINKLE & CITKOWSKI, P.C, PO BOX 7021, TROY, MI, 48007-7021, US

(21) Appl. No.: 11/287,670

(22) Filed: Nov. 28, 2005

Related U.S. Application Data
(62) Division of application No. 10/360,023, filed on Feb. 6, 2003.
(60) Provisional application No. 60/358,544, filed on Feb. 19, 2002.

(51) Int. Cl. G01N 27/416

(52) U.S. Cl. 324/426

(57) ABSTRACT

An apparatus for determining a condition parameter of a battery, receives measurement signals related to the battery, determines input data such as electrical impedance from the measurement signals, and provides the input data to a plurality of different prediction algorithms, wherein each prediction algorithm provides a condition parameter estimate. A plurality of condition parameter estimates are then provided to a decision fusion algorithm, allowing a more accurate prediction of the condition parameter.

### REFERENCE TO RELATED APPLICATION

This application is a divisional of U.S. patent application Ser. No. 10/360,023, filed Feb. 6, 2003, and claims priority from U.S. Provisional Patent Application Ser. No. 60/358,544, filed Feb. 19, 2002, the contents of both of which are incorporated herein by reference.

### FIELD OF THE INVENTION

The present invention relates to apparatus for determining the condition of a battery.

### BACKGROUND OF THE INVENTION

A battery is an arrangement of electrochemical cells configured to produce a certain terminal voltage and discharge capacity. Each cell in the battery is comprised of two electrodes where charge transfer reactions occur. The anode is the electrode at which an oxidation (O) reaction occurs. The cathode is the electrode at which a reduction (R) reaction occurs. The electrolyte provides a supply of chemical species required to complete the charge transfer reactions and a medium through which the species (ions) can move between the electrodes. The electrodes are often fabricated with an extended surface area such as an array of thin plates or sintered powder. The connection of such shapes with the terminals is accomplished through the anode and cathode current collectors. The electrodes are usually positioned in very close proximity to reduce ionic conduction path lengths. A separator is generally placed between the electrodes to maintain proper electrode separation despite deposition of corrosion products.

Different combinations of electroactive species produce different electrode potentials or voltages. The electrochemical reactions that occur at the electrodes can generally be reversed by application of a higher potential that reverses the current through the cell. In situations where the reverse reaction occurs at a lower potential than any collateral reaction, a rechargeable or secondary cell can potentially be produced. A cell that cannot be recharged because of an undesired reaction or an undesirable physical effect of cycling on the electrodes is called a primary cell.

The amount of electrical current that a battery can provide is governed by the reaction rates at the electrodes. The four processes that control the reaction rates of the electrodes are: (1) the mass transfer of the ions into the diffusion layer at the electrode surface area, (2) transfer of the electrons at the electrode surface, (3) intermediate reaction steps resulting from the chemical reaction in the diffusion layer and (4) other surface reactions such as adsorption or desorption of species. These processes represent the physical phenomena that occur in the battery.

Electrochemical cell processes are affected by a number of internal and external variables. Electrode variables include material, surface area, geometry, and surface conditions. Mass transfer variables include diffusion, convection, surface concentration, and adsorption. Solution variables include bulk concentration of electroactive species, concentration of electrolyte, and solvent used. Electrical variables include potential, current, and charge. External variables include temperature, pressure, and time.

Changes in the electrode surface, diffusion layer and solution are not directly observable without tearing the battery cell apart. Other variables such as potential, current and temperature are observable and can be used to indirectly determine the performance of physical processes.

For overall performance, the capacity and voltage of a cell are the primary specifications required for an application. The capacity is defined as the time integral of current delivered to a specified load before the terminal voltage drops below a predetermined cut-off voltage. For primary cells, the rated capacity is not strictly determinable but instead represents the statistical properties of test data for identical cells. The present condition of a cell is described nominally with a state of charge (SOC) that is usually defined as the ratio of the remaining capacity and nominal capacity. Obviously, in order to assess SOC, one must have knowledge of the service history of the cell and its nominal capacity. Secondary cells are observed to have a capacity that deteriorates over the service life of the cell. State of health (SOH) is used to describe the physical condition of the battery ranging from external behavior such as loss of rate capacity to internal behavior such as severe corrosion. Usually defined under SOH, the remaining life of the battery (i.e. how many cycles remain, time until battery voltage falls below cutoff, etc.) has been termed state of life (SOL), which is a reflection of the remaining time of use as opposed to a physical condition. Like many physical systems, maintenance of batteries is necessary for prevention of premature loss of life and poor performance.

There have been previous efforts to determine the SOC of batteries. In “Fuzzy Logic-Enhanced Electrochemical Impedance Spectroscopy (FLEEIS) to Determine Battery State-of-Charge,” Proceedings of the 15th Annual Battery Conference, Long Beach, Calif., Jan. 11-14, 2000, P. Singh et al. provide imaginary components of the battery impedance at three frequencies to a fuzzy logic algorithm trained on LiSO2 primary batteries. This approach fails to provide electrochemical model identification, and only provides an off-line SOC prediction, so that dynamic behavior is lost with consequent reduced performance of the system. There are also problems if the frequency characteristics of the battery impedance undergo a shift.

In “AC Impedance and State-of-Charge Analysis of Alkaline Zinc/Manganese Dioxide primary Cells,” Journal of Applied Electrochemistry, no. 30, pp. 371-377, 2000, S. Rodrigues et al. require the use of an inserted reference electrode, with off-line measurement of the positive electrode impedance. A least squares algorithm was used to identify the electrochemical parameters, so that good initial guesses were needed to prevent the algorithm getting trapped in a local minimum and not properly identifying the model, which will be a serious problem in an automated process.

Other previous efforts to determine SOC [such as D. O. Feder et al., “Conductance Testing Compared to Traditional Methods of Evaluating the Capacity of Value-Regulated Lead/Acid Batteries and Predicting State-of-Health,” Journal of Power Sources, no. 40, pp. 235-250, 1992; M. R. Laidig and J. W. Wurst, “Battery Failure Prediction,” BTECH, Inc. Publication, Whippany, N.J., 1997] used bulk impedance values. These methods try to find impedance values at different frequencies that result in a linear or monotonic progression. This approach suffers from problems similar to those discussed in the previous paragraph, and have additional constraints.

Models that produce cell or terminal voltage have also been used, for example to simulate the voltage produced under load until the cutoff voltage is reached. These models make a number of assumptions about the system. For example, initial SOC needs to be known, which represents a source for error. Also, aging of the battery is not addressed, which is another source for error. Impedance is not used in these models. Another non-impedance approach is coulomb counting, which simply uses the measured current to establish how much energy is removed for the battery. Again, this assumes accurate knowledge of the initial SOC and compensation for loading and temperature changes.

There have been few previous efforts to determine SOH (state of health) and SOL (state of life) of a battery. In “Predicting failure of Secondary Batteries,” Journal of Power Sources, no. 74, pp. 87-98, 1998, M. Urquidi-Macdonald and N. A. Bomberger made no attempt made to identify the failure mode and only externally observed measurements (terminal voltage, current, temperature we made). The neural network algorithm was trained and tested against data sets of similar life spans, which may lead to a false indication of life if a battery undergoes a different failure mode.

In “Impedance Spectroscopy as a Technique for Monitoring Aging Effects in Nickel Hydrogen and Nickel-Metal Hydride Batteries,” IEEE 35th International Power Sources Symposium, pp. 156-159, 1992, R. L. Smith et al. examine impedance values but not electrochemical model parameters for health related changes. Only a manual interpretation of the data was done and a prediction algorithm was not discussed.

D. Fox and P. McDermott, “Modeling Battery Life Through Changes in Voltage Fit Coefficients,” 1983 Goddard Space Flight Center Battery Workshop, pp. 125-163, Sponsored by NASA, Washington, D.C., USA, 1983, and S. Gross, “Analytical Modeling of Battery Cycle Life,” Journal of Power Sources, no. 12, pp. 317-322, 1984, use a parametric life model based on terminal voltage and remaining capacity. Training of these models does not address failure modes and how the models would be able to account for these.

In “Analysis and Interpretation of Conductance Measurements Used to Assess the State-of-Health of Valve Regulated Lead Acid Batteries,” 16th International Telecommunication Energy Conference, pp. 282-291, 1994, D. O. Feder and M. J. Hlavac use a bulk conductance (1/impedance) to find a linear trend, and the issue of failure mode identification is ignored. In “Battery Impedance Matching . . . An Added Dimension”, BTECH, Inc. Publication, Whippany, N.J., 1995, G. J. Markle addresses the need for identifying failure modes, but the measurement is limited to a single tone impedance value. This single measurement provides insufficient information about the electrochemical processes.

### SUMMARY OF THE INVENTION

Embodiments of the present invention provide a method for using measured information to determine the condition (including the health) of batteries, other electrochemical cells, and other systems where system properties such as electrical impedance can be correlated with the condition of the system, such as system health, lifetime, remaining life, charge, and the like. Embodiments of the present invention include a battery diagnostic system and battery diagnosis methods, wherein the condition of a battery can be determined.

The condition and health of a battery can be defined by three categories of condition parameter: State-of-Charge (SOC), State-of-Health (SOH), and State-of-Life (SOL). SOC is a measure of the amount of available energy in the battery. The processed information from this category can be reported in two forms, initial SOC before loading or charging and continuous SOC, which is the most recent measure of stored energy during discharging/charging. SOH is a measure of the physical condition of the underlining processes. For example, SOH may indicate the amount of passivation that has occurred or how much of the electrolyte has evaporated. SOL is a measure of the remaining usable energy. The processed information from this category is reported in two classes, Remaining-Useful-Energy (RUE) and Remaining-Useful-Cycles (RUC). RUE refers to the amount of stored energy remaining in the battery. This energy can refer to energy received from recharging or formation during manufacturing of new batteries.

Embodiments of the present invention describe new methods for assessing the condition of batteries, by determination of condition parameters correlated with the condition. A method to accurately assess the state-of-charge (SOC), state-of-health (SOH), and state-of-life (SOL) of primary and secondary batteries can provide significant benefits in operational systems. This method is based on accurate modeling of the transport mechanisms within the battery and requires careful development of electrochemical and thermal models. A novel impedance technique was previously developed to take wideband impedance data from the battery being tested. A feature extraction algorithm was implemented to identify physically meaningful information from the impedance data. These extracted virtual sensor signals (i.e. electrochemical process parameters) are saved along with the impedance data and other measured signal data into a feature vector file. The feature vector file provides input data for prediction algorithms. Three-prong Auto-Regressive Moving Average (ARMA), Neural Network, and Fuzzy Logic algorithms read this file to produce predictions of the SOC, SOH, and SOL. A decision fusion algorithm combines the predictions along with historical and system information to produce a more robust prediction and confidence level. The results of the fusion are then outputted to the user. The training of these algorithms can be achieved using data from lead-acid, nickel-cadmium, and lithium batteries as well as other types of various capacities, which can be run under different load, charging, and temperature conditions. The developed hardware and software can be implemented on both a laboratory test bench and a smaller portable system. These software-supported methods can provide improved diagnostic information about a battery under examination.

Embodiments of the present invention may be used in applications such as automotive and small vehicle batteries, electric vehicle systems, and backup power for communication, banking, medical, and computer network systems. In addition, the methodology could be used in other applications such as fuel cell diagnostics and online machine oil quality analysis.

The following terms are defined in relation to battery diagnostics. However, where the condition of other systems, cells, materials, or devices is of interest, the definitions can be modified appropriately. A measurement signal provides information correlated to the battery condition, such as terminal voltage, load or charge current, one or more temperatures, or a signal correlated with battery impedance. An electrochemical parameter relates to internal electrochemical processes within a battery, such as electrolyte resistance, charge transfer resistances, double-layer capacitances, and diffusion layer impedance coefficients. Electrolyte parameters can relate to the bulk electrolyte, one or more electrode surface regions, or electrodes. A feature vector is a data set determined by information comprising measurement signals, and provides information to one or more prediction algorithms. A prediction algorithm provides a prediction of a battery condition parameter, such as SOC, SOH, and SOL, based on received data, such as feature vectors, and the output of two or more prediction algorithms can be evaluated by a decision fusion algorithm so as to provide an improved prediction of a battery condition parameter, such as state of charge. A decision fusion algorithm provides a prediction of the battery condition parameter based on the predictions of two or more sources of data, such as prediction algorithms.

### BRIEF DESCRIPTION OF THE DRAWINGS

FIG. 1 shows a schematic of a predictive diagnostic system according to an embodiment of the present invention;

FIG. 2 shows a schematic of a model-based predictive diagnostic system;

FIG. 3 illustrates feature extraction processing;

FIG. 4 shows a processing path for state of charge (SOC) estimation;

FIG. 5 shows a processing path for state of health (SOH) classification;

FIG. 6 shows a processing path for remaining useful energy state of life (RUE SOL) prediction;

FIG. 7 shows a processing path for remaining useful cycles state of life (RUC SOL) prediction;

FIG. 8 shows a laboratory setup for a battery prognostics test bench;

FIG. 9 shows a system for battery prognostics;

FIG. 10 illustrates an ARMA model which may be used in embodiments of the present invention; and

FIG. 11 illustrates a training method for an ARMA model.

### DETAILED DESCRIPTION OF THE INVENTION

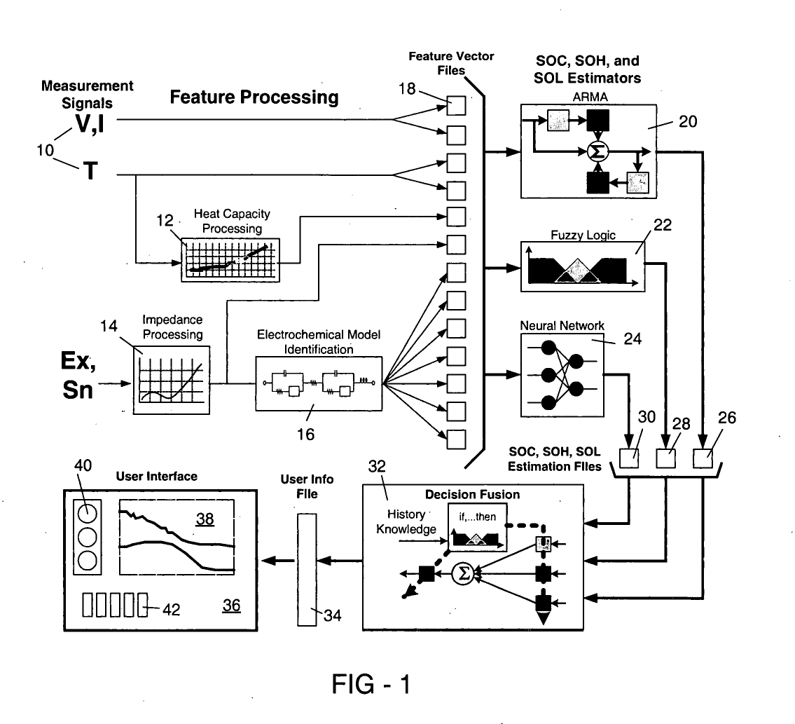

FIG. 1 shows a schematic of a predictive diagnostic system according to an embodiment of the present invention. For convenience, the following example will be discussed in relation to battery diagnosis, though a similar approach may be taken towards determining the condition of fuel cells, other electrochemical cells, and other systems providing condition-related data. A brief description of the system operation is provided below, with more detailed descriptions following. Measurement signals are received by the diagnostic system, for example as shown at 10. Measurement signals include electrical parameters such as battery voltage (V) and current (I), temperature (T), and an electrical signal (Sn) generated in response to an electrical excitation (Ex) of the battery. Impedance processing 14 is used to determine battery impedance data as a function of excitation frequency. The impedance data is then fitted by an electrochemical model 16, so as to provide electrochemical parameters relating to the battery. A feature vector 18 comprises one or more data files generated from the measurement signals. The information contained within the feature vector 18 is used by three prediction algorithms, an auto-regressive moving-average (ARMA) algorithm 20, a fuzzy logic algorithm 22, and a neural network algorithm 24. Three estimation files 26, 28, and 30 are provided with estimations of SOC, SOH, and SOL by the ARMA, fuzzy logic, and neural network algorithms.

A decision fusion algorithm 32, alternatively referred to as a fusion algorithm, determines values of SOC, SOH, and SOL from values in the estimation files. The output of the decision fusion algorithm is output into a user information file 34, and is provided to a user interface 36. Data may be displayed to a user using a display 38 or indicator lamps such as 40. The user interface further comprises a data input mechanism 42, through which information relating to the battery can be input.

The measurement signals may be data sampled from an analog to digital converter receiving analog signals from an appropriate sensor. The battery current (I) may be a charge or load current. The temperature (T) may be an internal temperature of the battery, a surface temperature such as measured on the case or a terminal, and/or an ambient temperature measurement.

Measurement signals may be continuously monitored, or sampled at time intervals appropriate to the application. For example, measurement signals from a lead acid battery in a gasoline-powered vehicle may be collected at intervals of, for example, 1-20 minutes, 10 minutes being one specific example. Measurement signals from a battery in storage, or part of equipment in storage, may be collected at daily or weekly intervals. Measurement signals from a battery or fuel cell in an electrically powered or hybrid vehicle may be collected continuously or at intervals in the range 0.01-10 minutes.

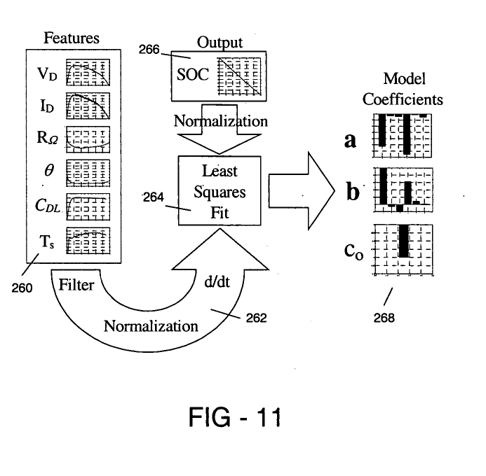

Impedance processing 14 comprises determination of battery impedance data over a range of frequencies. The data can be processed and analyzed in the form of a Nyquist plot of impedance data, for example as illustrated in FIG. 11 of U.S. Pat. No. 6,307,378, the entire contents of which are incorporated herein by reference. Impedance data alone (without additional electrical parameters) were found sufficient to provide accurate diagnostics of battery condition. As is well known in the art, electrical impedance data can be generated by providing a small electrical excitation current to a battery, at one or more frequencies, and receiving a signal current. The excitation (Ex) and signal (Sn) electrical signals can be provided by circuitry such as described in U.S. Pat. No. 6,307,378. Other techniques, such as a conventional four-wire method, can also be used.

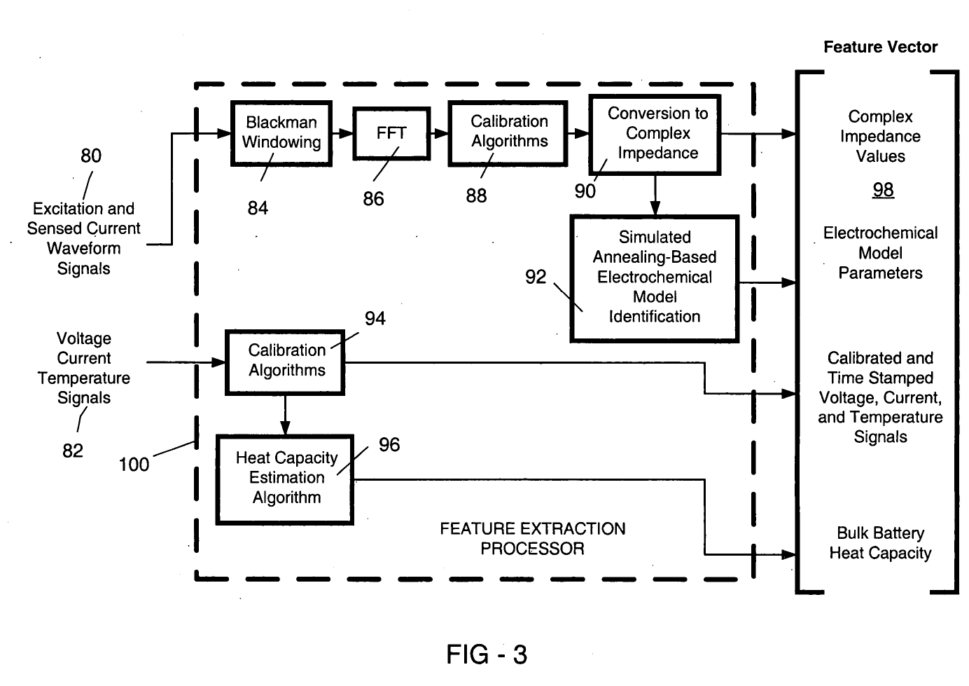

In electrochemical model identification, the impedance data is analyzed so as to provide electrochemical parameters. The provision of electrochemical parameters to the prediction algorithms allows increased accuracy, in comparison with systems where, for example, impedance data at one or more frequencies are used. The frequency range of impedance determinations is preferably wide enough to allow fitting by an electrochemical model, so as to determine electrochemical parameters such as electrolyte conductivity. Electrochemical models are known in the art, but have not been used previously to provide electrochemical parameters to one or more prediction algorithms. This is discussed in more detail below, in relation to FIG. 3.

A simulated annealing algorithm was used to fit impedance data to an electrochemical model. Simulated annealing methods are well known in the mathematical arts, but have not previously been used to provide electrochemical parameters to predictive algorithms so as to determine battery condition parameters. The symmetry of electrochemical models can cause a problem with a simulated annealing algorithm, as there may be two solutions, only one of which is correct. Data obtained previously from test or training runs can be used to identify the correct solution. Modeling can be constrained to provide solutions close to earlier fittings. For example, the model can be constrained such that the solution closest to the previously correct solution is chosen, thereby avoiding selection of the other solution.

The three algorithms used as predictive algorithms in this example (ARMA, fuzzy logic, and neural network) are well known to those skilled in the mathematical arts, and further details are not provided here. Decision fusion algorithms, sometimes called data fusion algorithms, are also well known to those skilled in the mathematical arts. The parallel use of more than one algorithm to predict battery condition has never been described previously. The use of a decision fusion algorithm to find battery condition from the outputs of more than one predictive algorithm has also not been previously reported.

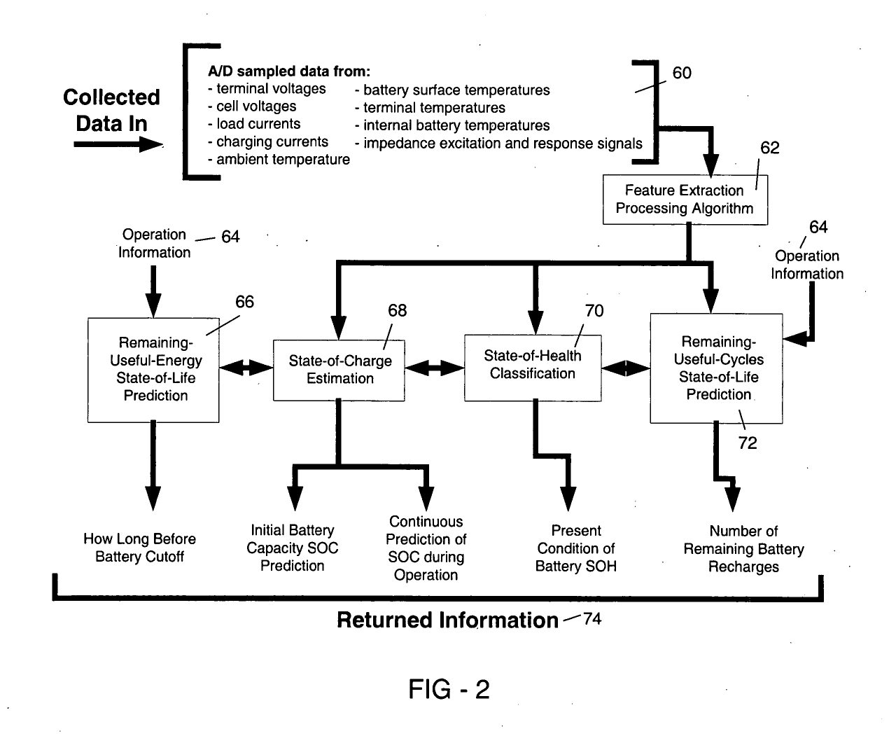

FIG. 2 shows the top-level description of a model-based predictive diagnostics system, which can be used to diagnose the condition of primary and secondary batteries. Collected data 60, such as measurement signals, are passed to a feature extraction processing algorithm 62 and passed to three routines, a state of charge (SOC) estimation 68, a state of health (SOH) estimation 70, and a remaining-useful-cycles state of life (RUC-SOL) prediction 72. Operation information 64 is used in determining a remaining useful energy state of life (RUE-SOL) prediction 66, and also influences the remaining-useful-cycles state of life (RUC-SOL) prediction.

The model-based predictive diagnostics system returns five diagnostics measures (condition parameters) as returned information (74):

1) The initial SOC, which is the amount of available energy prior to discharging or after charging,

2) A continuous measure of the SOC, which is the current amount of energy in the battery as it is being discharged or charged,

3) The amount of time remaining until the battery falls below cutoff voltage during discharging or has reach full charge during charging,

4) The SOH of the battery, which is a classification of the battery health in terms of the physical failure mechanisms, but could be reduced to higher level indications such as “good,” “ok,” and “bad,” and

5) The remaining number of recharges a battery can undergo.

The inputs to the feature extraction processing are measured observables of the monitored battery, which include (but are not limited to) terminal and cell voltage, load and charge current, ambient, surface and internal battery temperatures, and impedance excitation and sensing signals such as current waveforms.

There are four main processing paths that the data can take. However, each of these paths includes the feature extraction processing. This processing block calibrates raw data signals and extracts features from the raw sampled data.

FIG. 3 shows a schematic of an example feature extraction processor 100, which calibrates the measured voltage, current, and temperature signals and then outputs them to a feature vector. The excitation and sensed current waveforms 80 are first windowed using a Blackman window 84. These signals are then passed through an FFT (Fast Fourier Transform) algorithm 86 to extract phase and magnitude information at the frequencies of interest. The signals then pass through calibration algorithms 88, with conversion to complex impedance at 90.

Voltage, current, and temperature signals 82 are calibrated using calibration algorithms 94 and the calibrated data passed to the feature vector 98. Temperature signals are passed to a heat capacity estimation algorithm 96, to provide bulk battery heat capacity data to the feature vector 98.

In one embodiment, the measurement signals such as the terminal/cell voltage, load/charge current, and temperatures are fed to a calibration module, which uses stored information about each channel to insure that data is accurate in reference to collected calibration data. These calibrated signals are then written to the feature vector, a file that contains these calibrated signals, a time stamp, impedance data points, a heat capacity estimate, and identified electrochemical model parameters. Ambient, surface, and internal temperature signals are fed into a bulk heat capacity estimator and this value saved to the feature vector.

In one embodiment, the excitation signal 80 has 52 log-spaced frequencies from 1 Hz to 17.7 kHz. In other embodiments, impedance data collection may include frequencies within the ranges 1 Hz-10 KHz, 10 Hz-10 kHz, 100 Hz-10 kHz, 1 Hz-1 KHz, 1 Hz-100 Hz, 10 Hz-1 kHz, or other ranges as appropriate. The extracted phase and magnitude signals are then calibrated and converted to complex impedance values for each of the frequencies of interest.

The Blackman window 84 has better phase preservation performance than Hannon or rectangular windows. However any appropriate signal processing or analysis technique may be used.

An impedance technique for taking wideband impedance data from the battery being tested is described in U.S. Pat. No. 6,307,378. These impedance values are then outputted to the feature vector. The impedance values are also passed to the electrochemical model identification processing, which identifies seven parameters: electrolyte resistance, two charge transfer resistances, two double-layer capacitance, and two diffusion layer impedance coefficients.

The identification algorithm 92 is based on a simulated annealing search routine with enhancements to prevent parameter swapping due to model symmetries and parameter trajectory switching due to path crossings. The identified parameters are then outputted to the feature vector 98. This vector is fed into the four processes that calculate the SOC, SOH, and SOL of the battery.

Electrochemical models which may be used are known in the art. A Randles circuit can be used for the electrode-electrolyte interface process. A single electrode model for cell impedance is given by:

$${Z}_{cell} ( s ) = {R}_{Ω} + \frac{{s}^{1 / 2} θ + σ \sqrt{2}}{{s}^{3 / 2} θ {C}_{DL} + {sC}_{DL} σ \sqrt{2} + {s}^{1 / 2}} \qquad ( 1 )$$

In 1, s=jω (ω is frequency in rad/s), R_{Ω} represents the electrolyte resistance, θ represents the charge transfer resistance, C_{DL} represents the double layer capacitance, σ represents the diffusion layer coefficient, and Z_{w} represents the Warburg impedance. The double layer capacitance is a result of the ions in the electrolyte and the electrons in the electrode waiting to participate in the chemical reactions. The build up of these charged particles results in a charged layer (i.e. capacitance). The Warburg impedance is related to the mass transfer into the diffusion layer. The general solution of the Equation 1 can be found in the form of a Nyquist plot, as is well known in the electrical arts.

The most common types of battery failures include passivation, separation, bridging, dry-out, sulfation, softening, corrosion and various mechanical failures. The Randles circuit has good application not only for identifying the SOC independent of cell polarization but certain SOH failures. For example, lead-acid batteries tend to suffer from sulfation, which has shown to be associated with an increase in charge transfer resistance. Drying out of the electrolyte manifests in the Randles circuit as an increase in the ohmic resistance. Corrosion of the electrode changes the porosity of the electrode and reduces the slope of the linear leg, as is known in the art. A good fit of the impedance data was found using a two-electrode, Randles circuit model including a wiring inductance.

There are a number of steepest-decent methods for nonlinear equations such as recursive least squares (most common for impedance modeling) and simplex methods known in the art. These methods are only local minima search algorithms. In an offline scenario when the impedance data can be inspected visually on a Nyquist plot, good initial guesses can be made and re-made. However, in an online automated identification process, this may not be an option and a good initial guess for one data set may not be good for the next identification. These methods would not be robust and provide a false indication of parameters changes.

Global search methods are also available for model identification such as genetic algorithms and simulated annealing. However, genetic algorithms do not always find the global minima. Simulated annealing was shown to be able to find the global minima but at the cost of many more iterations. There are a number of hybrid techniques available to address these issues as well. In one embodiment, a simulated annealing algorithm was used to identify model parameters. Search regions, based on the identified parameters from previous impedance measurements, were used to minimize processing iterations.

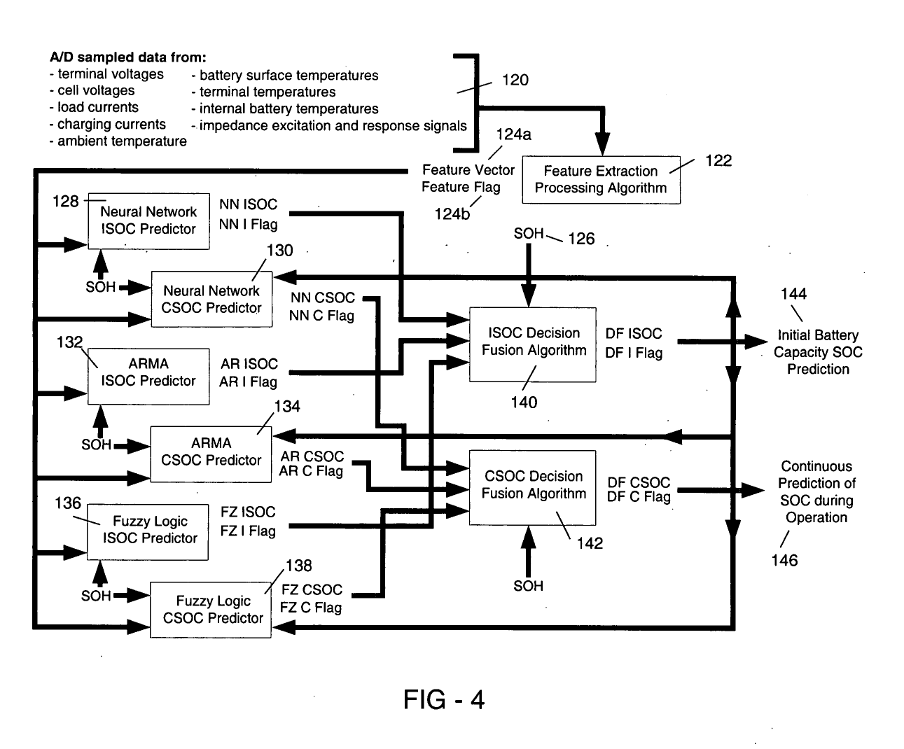

FIG. 4 shows a processing path for state of charge (SOC) estimation. There are four stages of the SOC processing: initial SOC estimations, decision fusion applied to the initial SOC estimations, continuous SOC estimations, and decision fusion applied to the continuous SOC estimations. The SOC processing module is fed the feature vector information and outputs the initial SOC and a current estimate of the SOC if a load or charging is applied.

Information 120, is received and passed to one or more feature extraction processing algorithm 122, for example as illustrated in FIG. 3.

Measurement signals 120 such as terminal voltages, cell voltages, load current, charging current, ambient temperature, battery surface temperature, terminal temperature, internal battery temperature, and impedance signals) are passed to a feature extraction processing algorithm 122, which generates a feature vector 124a and a feature flag 124b. The algorithm 122 may comprise one or more signal processing steps and data processing algorithms, for example as illustrated in FIG. 3. Data from the feature vector is passed to three predictive algorithms: a neural network, an ARMA algorithm, and a fuzzy logic algorithm.

For initial battery capacity state of charge (initial SOC or ISOC) estimation, data is passed to a neural network ISOC predictor 128, an ARMA ISOC predictor 132, and a fuzzy logic ISOC predictor 136. The three ISOC predictions (shown in FIG. 4 as NN ISOC, AR ISOC, and FZ ISOC) are passed to the ISOC decision fusion algorithm 140. The decision fusion algorithm provides a prediction of ISOC 144 using the predictions from the three predictive algorithms.

For continuous prediction of SOC during operation (CSOC), data from the feature 124a vector is passed to the neural network CSOC predictor 130, ARMA CSOC predictor 134, and the fuzzy logic CSOC predictor 138. The three CSOC predictions (shown in FIG. 4 as NN CSOC, AR CSOC, and FZ CSOC) are passed to the CSOC decision fusion algorithm 142. The decision fusion algorithm provides a prediction of CSOC 146 using the predictions from the three predictive algorithms.

Measurement signals can be data sampled at intervals using an analog-to-digital converter (as indicated in FIG. 4), or may comprise other data inputs of any appropriate form or origin.

Flags generated include the neural network ISOC prediction flag (NN I Flag), ARMA ISOC flag (AR I Flag), fuzzy logic ISOC prediction flag (FZ I Flag), corresponding flags for CSOC determinations by the three predictive algorithms (NN C flag, AR C flag, and FZ C flag), feature vector flag, and flags generated by the ISOC decision fusion algorithm 140 (DF I Flag) and CSOC decision fusion algorithm 142 (DF C Flag). Flags can be used to provide error messages, confidence levels, and the like, and may be used by algorithms to provide weighting factors. In other embodiments, flags need not be generated, or only a subset of the listed flags generated.

ISOC and CSOC determinations can be fed back to the prediction algorithms. The state of health (SOH) of the battery 126, which can include the number of previous discharge cycles and/or battery age, can also be used to assist determine ISOC using the three predictive algorithms, and within the fusion algorithms 140 and 142.

As shown in FIG. 4, the initial SOC (ISOC) processing is performed by three separate algorithms, which produce separate estimations of the initial SOC (ISOC). Neural network, auto-regressive moving-average (ARMA), and fuzzy logic algorithms are trained and used to perform the estimations. These three estimates are fed into a decision fusion algorithm that weights the estimates based on a confidence measure. The confidence measure uses information about the SOC algorithms, previous performance, etc. The initial SOC will change based on load or charging method, so this estimation is updated continuously to account for changes in the loading or charging.

For estimation of the most recent SOC (continuous SOC, or CSOC), neural network, ARMA, and fuzzy logic algorithms are used and produce three separate estimations of the most recent SOC. This processing stage uses the feature vector information and initial SOC estimation from the decision fusion process to make the estimations. The three estimations are fed into a decision fusion algorithm 142 that weights the SOC estimates based on a confidence similar to the decision fusion processing for the initial SOC. The neural network, ARMA, fuzzy logic, and decision fusion processing algorithms are updated based on SOH information fed in from the SOH classification-processing path.

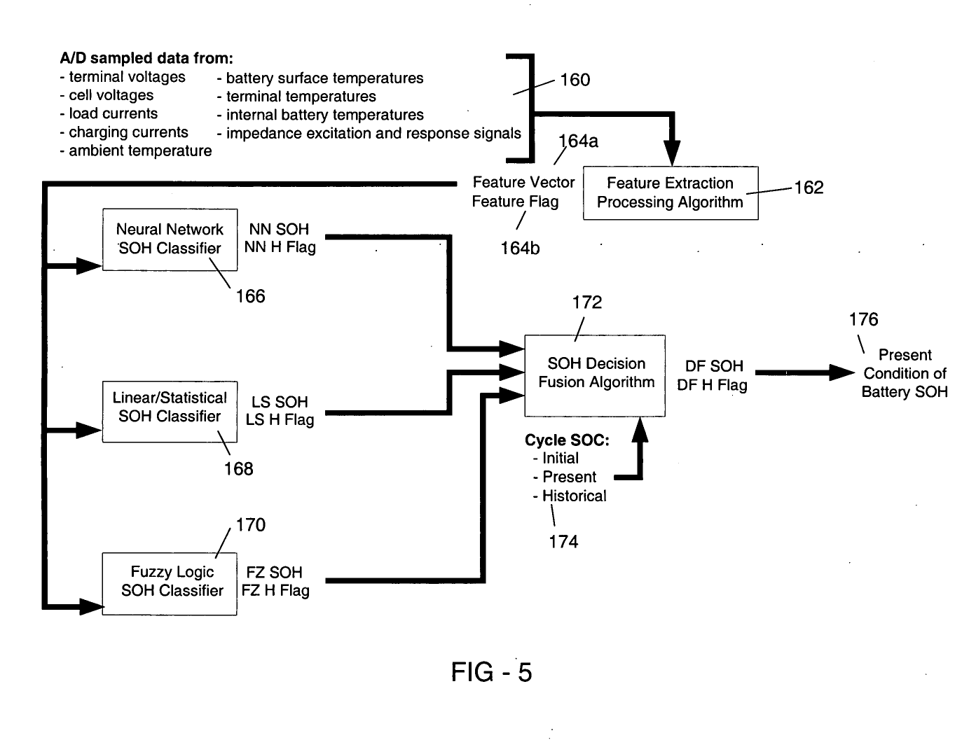

FIG. 5 shows a processing path for state of health (SOH) classification. Measurement signals 160, comprising measurement signals such as terminal voltages, cell voltages, load current, charging current, ambient temperature, battery surface temperature, terminal temperature, internal battery temperature, and impedance signals is received and passed to one or more feature extraction processing algorithms, for example as illustrated in FIG. 3. The algorithm 162 generates a feature vector 164a and a feature flag 164b. The information contained in the feature vector 164a is used by three prediction algorithms, a neural network SOH classifier 166, a linear/statistical SOH classifier 168, and a fuzzy logic SOH classifier 170. The outputs of the three prediction algorithms, a prediction of the SOH and a flag, are passed to a SOH decision fusion algorithm 172. The decision fusion algorithm 172 also receives information 174 related to cycle SOC, for example initial, present, and historical values. The decision fusion algorithm produces an SOH (DF SOH) prediction and a decision fusion SOH flag (DF H Flag). The present condition parameter (battery SOH) is presented to the user (176).

The SOH processing flow uses the feature vector information to classify the physical condition of the battery. As with the SOC estimation processing, three separate algorithms are used to classify the current health of the battery. The classification segregation is based on failure mechanism. The three classifications are fed into a decision fusion-processing block. The output of the fusion processing is a refined classification based on classification agreement, previous performance of each of the classifiers, etc. The SOH processing can provide this information to the user/interface as well as being used to update SOC estimation processing and SOL prediction for remaining recharging life.

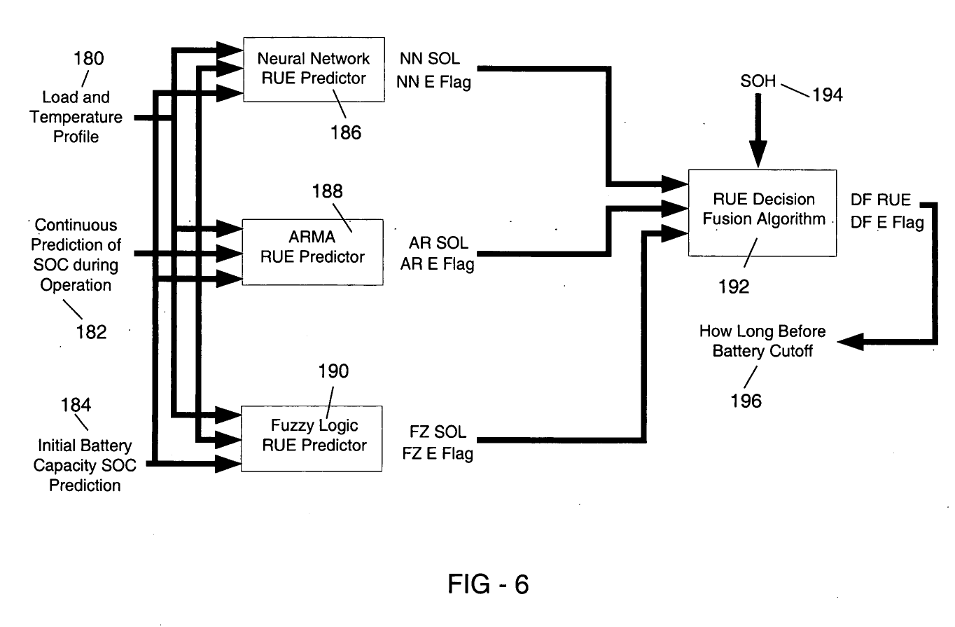

FIG. 6 shows a processing path for remaining useful energy state of life (RUE SOL) prediction. Information, for example derived from measurement signals and other processing steps as described in more detail elsewhere, is passed to three prediction algorithms. The information comprises load and temperature profiles 180, continuous prediction of SOC during operation (CSOC) 182, and initial battery capacity SOC (ISOC) 184. The three algorithms are a neural network (NN) RUE predictor 186, an ARMA RUE predictor 188, and a fuzzy logic (FZ) RUE predictor 190. The NN predictor 186 produces an NN SOL prediction, the ARMA RUE predictor 188 produces an AR SOL prediction, and the FZ RUE predictor 190 produces an FZ SOL prediction. The three predictions are passed to a RUE decision fusion algorithm 192, which produces a decision fusion (DF) prediction of RUE (DF RUE prediction), which is then used to determine how long before the battery cut-off 196.

The fusion algorithm 192 also receives battery state of health (SOH) data 194, which can be used to assist determination of RUE. For example, as state of health degrades over time or battery cycles, different weights can be given to the prediction algorithm outputs. The appropriate weights can be determined in a training step.

This particular branch of the processing provides the user/interface with a prediction of the remaining time in the discharge or charge cycle. This processing branch uses the initial and continuous SOC information from the SOC processing branch along with loading/charging and temperature profiles to make a prediction on the remaining time left in the cycle. The three-prong separate prediction algorithm approach is used in this branch as well. Neural network, ARMA, and fuzzy logic algorithms are employed to make the three separate predictions. These predictions are then fed into a decision fusion-processing block where they are weighted based on a confidence measure.

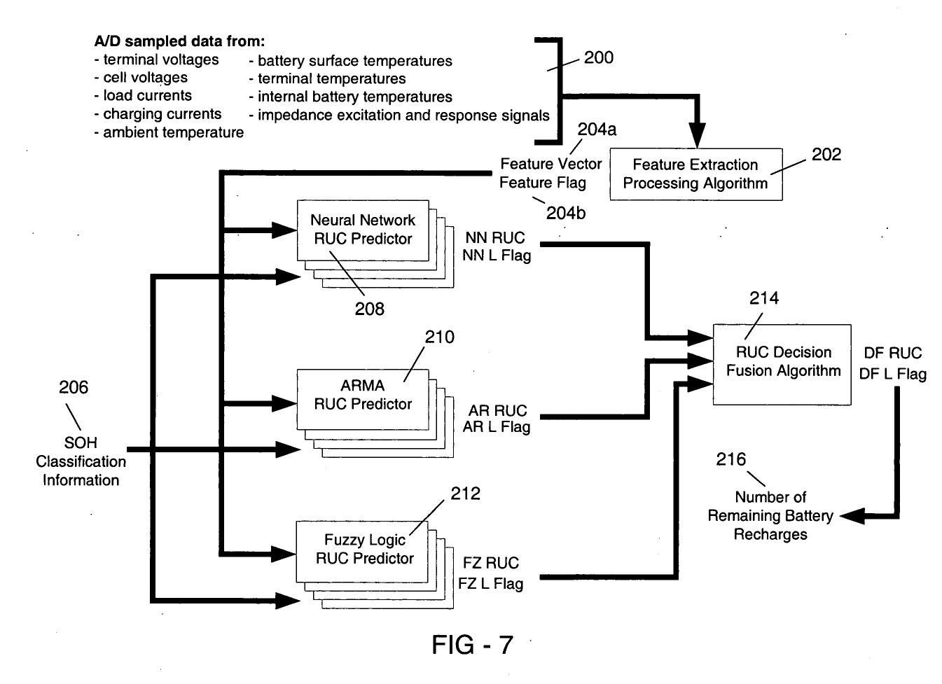

FIG. 7 shows the RUC SOL prediction-processing path. This branch of the processing predicts the remaining number of recharges. The three-prong prediction algorithm approach model is used in this branch as well. However, the prediction models are updated or modified based on SOH classification. Since different failure mechanisms age the battery at different rates, using a single prediction model would limit performance. For example, corrosion will age the battery at a different rate than passivation and this translates to a different end of life point. Also, more than one failure mechanism may be aging the battery and prediction performance will improve as one of the failure mechanisms begins to dominant the health of the battery.

Information 200, comprising measurement signals such as terminal voltages, cell voltages, load current, charging current, ambient temperature, battery surface temperature, terminal temperature, internal battery temperature, and impedance signals is received and passed to a feature extraction processing algorithm 202, for example as illustrated in FIG. 3. This provides a feature vector 204a and a feature flag 204b. The feature vector 204a provides information for the three prediction algorithms: the neural network RUC predictor 208, the ARMA RUC predictor 210, and the fuzzy logic RUC predictor 212. SOH classification information 206 is also provided to the three algorithms. The three algorithms each produce a RUC prediction and flag. The three RUC predictions are passed to the RUC decision fusion algorithm 214, which produces a RUC prediction (DF RUC) and a flag. The RUC prediction is used to determine the number of remaining battery recharges 216.

Hence, a method for processing measured electrochemical monitored signals, executed by a computer comprises using a feature extraction processing algorithm to generate complex impedance values, electrochemical model parameters, calibrated and time stamped voltage signals, calibrated and time stamped current signals, calibrated and time stamped temperature signals, and information regarding bulk battery heat capacity; and transferring the information generated by the feature extraction processing algorithm to a remaining useful energy state-of-life predictor, a state-of-charge estimator, a state-of-health classifier and a remaining useful cycle state-of-life predictor, thereby generating a measurement of the time period remaining until battery depletion, a measurement of initial battery state-of-charge, a measurement of battery state-of-charge during operation, a measurement of battery state-of-health and a measurement of the number of remaining battery recharges. The electrochemical monitored signals may comprise terminal voltage, cell voltage, load current, charging current, ambient temperature, battery surface temperature, terminal temperature, internal battery temperature and impedance excitation and response. The information generated by the feature extraction processing algorithm may be capable of being transferred simultaneously or individually.

An improved electrochemical signal processing system comprises means for storing electrochemical monitored signals, means for generating a database of complex impedance values using feature extraction processing; and means for transferring information generated by feature extraction processing to a state-of-life predictor, a state-of-charge estimator and a state-of-health classifier. The system may further comprise a battery and a digital user interface.

According to one preferred embodiment of the present invention, the feature extraction processing algorithm may be run using only the impedance data as an input. The voltage, current, and temperature data are not required. Alternatively, other subsets of the inputs discussed hereinabove may be used as inputs to the feature extraction processor. Likewise, the data supplied to the feature vector files may be a subset of the data discussed hereinabove.

Test Bench Setup and Prototype Hardware

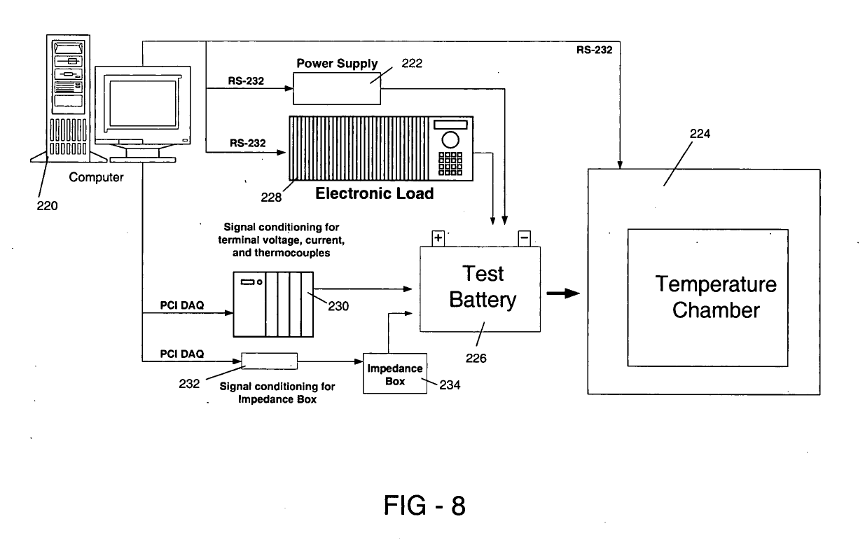

FIG. 8 shows an example laboratory setup that was designed to run batteries under prescribed load/charge and temperature conditions, and provides a laboratory setup for a battery prognostics test bench. This should be considered only an example, since not all portions are necessary, or even preferred, for the practice of the present invention (for example, the use of a temperature chamber and an electronic load are not required for some applications). The invention could alternatively be implemented on a PC or an embedded system.

The system comprises a computer 220, power supply 222, temperature chamber 224, battery under test 226, electronic load 228, signal conditioning hardware 230 for terminal voltage, current, and thermocouples, an impedance box 2434, and signal conditioning hardware 232 for the impedance box 234.

The description of the laboratory setup can be divided into three sections: control of conditions, signal measurement and conditioning, and data sampling and collection. The two main controls for running a battery test are the load/charging and temperature of the battery, which are the key influences on available battery charge and life. An electronic load 228 was used to discharge the batteries and is controlled via an RS-232 connection to the workstation PC 220. The electronic load is capable of constant resistance (CR), constant current (CC), constant voltage (CV), and constant power (CP) loading. For charging the batteries a variable power supply 222 was used and is capable of charging under constant voltage (CV) or constant current (CC) conditions. The power supply is controlled via an RS-232 connection to the workstation PC 220. Also, a temperature chamber 224 was used to test batteries from −20° C. to 150° C. and is controlled by the workstation PC via RS-232 serial interface.

The measurement signals for battery diagnostics included: cell and terminal voltage, load and charging current, ambient, case surface, and internal cell temperatures, electrolyte pH, and wideband electrical impedance. To acquire these signals, signal conditioning hardware 230 was selected that could handle these different types of measurements. The National Instruments SCXI-based signal conditional equipment was selected since it could handle voltage, current, and thermocouple signals over a wide range and was modular for easy configuration and modifications. Also, the bandwidth for this signal condition hardware was set at 4 Hz, which was more than sufficient for the voltage, current, and temperature signals. Impedance measurements were made using the methods described in U.S. Pat. No. 6,307,378. An AC ground circuit was used to reduce the required voltage rating (and subsequent physical size) of the DC blocking capacitor. The impedance measurement hardware 232 produces two signals for the impedance and each channel has a bandwidth of 20 kHz, which is a much higher sampling requirement than the other signals measured on the battery.

The analog signals were digitally sampled using two data acquisition (DAQ) boards installed into the workstation PC 220. The first of the two DAQ boards was used to control the SCXI hardware and sample the voltage, current, thermocouple, and pH signals at a rate of 10 sample/s. The second DAQ board was used to sample the two signals from the impedance measurement hardware box and sampled these signals at a rate of 5,000 samples/s and 200,000 samples/s (based on interrogation waveform bandwidth). Data sampling was done in 10 windows in 1-minute intervals and each data sampling for each signal was saved as an individual file. Having the data partitioned in the manner is less susceptible to corruption than if the all the data is saved as one large file.

Test Runs and Procedures

In order to have data that was representative of operational conditions, test runs were designed to cover those conditions that predominantly affect the battery state. The four main factors considered for test design were: 1) operating temperature, 2) loading/charging current, 3) battery chemistry, and 4) capacity size.

Test runs were conducted under the following procedure:

1. A battery chemistry and size was selected for the run series and the type of measurements for that battery were determined (e.g. terminal voltage, surface temperature, etc.).

2. The loading, charging, and temperature profiles were selected and a schedule for running the test was drawn up.

3. Calibration information for each of the sensors was collected and examined for faults in the sensors or instrumentation.

4. The DAQ software was configured for collection of the selected sensors signals and data sampling speeds and block sizes. Also, the loading, charging, and temperature profiles were configured into the DAQ software, which was designed to control these battery conditions.

5. A set of “no-load” measurements of the battery were sampled and saved. 6. The test cycle was then initiated under the following test conditions:

a. If the test battery was a primary battery, the battery was discharged until the cutoff voltage was reached and “no-load” measurements were taken once the terminal voltage of the battery reached a steady-state level (in addition to the measurements taken online during discharge).

b. If the test battery was a secondary battery, after discharge and “no-load” measurements, the battery was charged and measurements were taking online during the charging and after charging.

7. The collected data was then moved to the data archive server.

8. The feature extraction processing software was used to generate a Feature Vector file and was saved with the archived test run data.

9. Repeat the process steps 1-8 for each battery in the test series.

10. For cycle life testing, run each battery until the post-charging capacity falls below the selected run-terminating capacity level or until a permanent failure occurs such as an open circuit or short circuit.

The test run order was randomized for series that had multiple temperature and load profiles to reduce any biasing that may be attributed to arbitrary external influences such as other test rigs running in the area and test rig operator control. It should be noted that this is only an example test run, and is not necessarily required for the present invention.

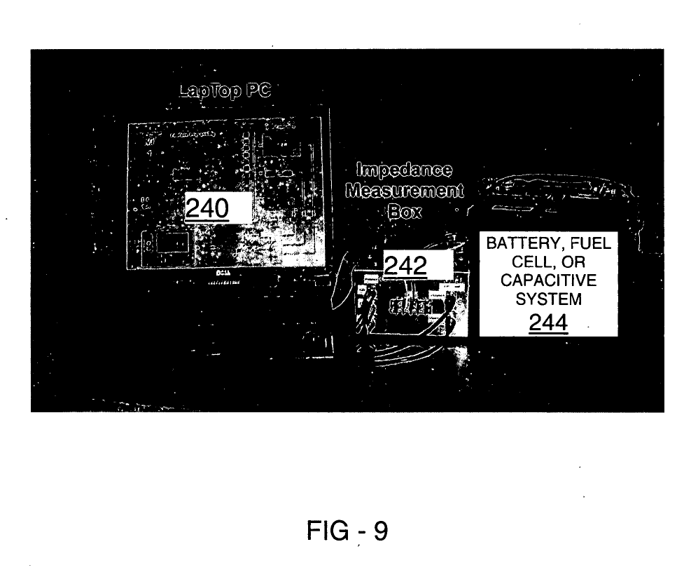

FIG. 9 illustrates a portable system that could be taken into the field to test a battery 244 (for example in vehicles and equipment), comprising a laptop computer 240 and an impedance measurement box 242.

A self-contained apparatus was also constructed, having a housing with dimensions of approximately 2″×4″×1.5″. The housing contains a processor, memory, data input mechanism (for receiving identification data relating to a battery under test), a pair of electrical connectors to connect to the battery under test, battery impedance measurement circuitry, impedance data processing circuitry, and a display. Software, executed by the processor, was operable to provide a fuzzy logic prediction algorithm, an ARMA prediction algorithm, a neural network prediction algorithm, and a decision fusion algorithm. The device was operable to determine battery impedance over a range of frequencies, extract electrochemical parameters from the impedance data, provide information comprising the electrochemical parameters to three prediction algorithms (as described in detail above), and determine battery conditions by passing the outputs of the three prediction algorithms to a decision fusion algorithm. A two-electrode electrochemical model, as will be familiar to those skilled in the relevant art, was used. An analog-to-digital converter can be used to convert analog signals (such as terminal voltage) to digital signals. In one embodiment, the only measurement signal received by the device related to battery impedance. The device provided an excitation signal to the battery through electrical contacts in electrical communication with the battery.

An apparatus according to the present invention can be trained on a specific battery. In other embodiments, a user enters a battery model number (for example, a brand name and any other product identification number), and training files corresponding to that model are used in predicting required battery conditions. If training files are not available for a specific product, files for a similar battery may be used, for example a battery of similar chemistry and charge capacity. The product identifier, vehicle identifier, or similar identifier from a device, vehicle, or other equipment containing the battery may be used to identify the battery and call up the appropriate training files. The decision fusion algorithm may keep learning as the algorithm is used, so that data under certain conditions is deweighted.

Training files may comprise data collected in relation to a specific cell, or class or model of cell, and used later by prediction and/or decision fusion algorithms to improve accuracy.

A device to assist with battery diagnostics may be a stand-alone unit, receiving signals from a battery and communicating with a portable computing device so as to use the display capabilities and processing power of the computing device. A device may take the form of an accessory within, connected to, or otherwise in communication with a host electronic device, for example a card inserted into a computer.

Further Information Concerning Prediction Algorithms

ARMA Algorithm

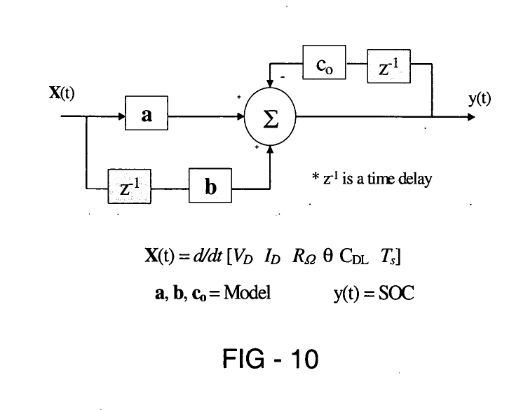

FIG. 10 illustrates an ARMA model which may be used in embodiments of the present invention. ARMA models are commonly used for system identification because they are linear and easy to implement, and complement the more complex models (neural network and fuzzy logic) being used. A second order model was sufficient to predict SOC. The model (illustrated in FIG. 10) is represented by the equation, with y
y(t)=aX(t)+bX(t−1)+cₒ y(t−1) (2)
representing SOC, X representing a vector of model inputs, and a, b, and cₒ representing the model coefficients (determined from the LS (least squares) fit during ARMA training).

Measured impedance data, as previously described, can be used in the model. These variables represent the electrochemical processes occurring inside the battery during its discharge and are dependent on the amount of charge remaining in the battery. The electrolyte resistance (R_{Ω}), for example, is representative of the amount of electrolyte that is available for reaction. The lower the amount of electrolyte, the less available capacity there is remaining in the battery.

Furthermore, the charge transfer resistance (θ) represents the amount of plate surface area that is available for reaction. This value decreases as the SOC decreases. Finally, the double layer capacitance (C_{DL}) represents the number of ions that are waiting to react in the battery. This value increases as the amount of available capacity decreases due in part to the diminishing amount of electrolyte and plate surface area. These characteristics make impedance measurements a good indication of battery's SOC.

Inputs can be preprocessed before being entered into the model. To eliminate measurement noise, model inputs were first filtered before being entered into the model. A Butterworth filter was used to remove high frequency noise from the signals. Other filters may be used.

Input preconditioning can also be used. Preconditioning made training of the model more effective by creating inputs with consistent behavior, regardless of battery conditions. The derivative of each input can be made prior to entry into the model. Then, all of the model inputs may have a similar shape when plotted against SOC. Because of the possible wide range of values of the inputs, normalization of the parameters prior to entry into the model may be helpful. This allows the model coefficients to be similar in size and helps eliminate one input from dominating the model. For example, each input can be normalized with regards to the minimum and maximum values of the training set.

The SOC from the previous prediction can be used in order to make a new SOC prediction. This creates a problem when making the first prediction, however, because the initial SOC of the battery is unknown. Assuming the battery always begins with 100% SOC may not be efficient if this value is dependent on such things as manufacturing and shelf life. Therefore, the longer a battery sits without being used, the more charge is lost and its initial SOC is diminished. Also, charging efficiency in secondary cells causes a variation in initial battery capacity. In addition, a battery may have been partially discharged prior to use. No load SOC prediction methods may be used, which use impedance measurements that are taken before the load is applied to the battery. There is a relationship between these “No Load Condition” measurements and the amount of capacity (or SOC) that is available in the battery.

FIG. 11 illustrates training of the ARMA model. The ARMA model may be trained in order to use the ARMA model to make a SOC prediction. This can be done by selecting a training set of data from a completed cycle. Because the entire set of data is available, the endpoint of the cycle is known and the actual SOC of the battery at each point can be calculated. A feature set 260 passes through filter and normalization stage 262. The model then uses a least squares (LS) fit 264 to calculate the model coefficients 268 that enable the inputs to result in the actual SOC (266). These model coefficients are then used for each successive run to calculate the SOC. The LS routine uses the equation:
α=[Σφ(t)φ^{T}(t)]⁻¹ Σφ(t)y(t) (5.B)

with α representing the calculated model coefficients, φ(t) representing a vector containing model inputs and output feedback, and y(t) representing the known model output.

Modeling of secondary cells can differ from modeling of primary cells because of health effects on a battery's SOC. As a battery's health diminishes, its initial SOC and internal impedance decrease. In order to account for this, secondary cells use a recursive training routine in which the model is retrained after each cycle to be used for the prediction of the next cycle. This helps eliminate the effects of SOL and the changing impedance of the battery as its health diminishes.

Neural Network

Neural networks are well known in the computing and mathematical arts, and will not be described further here. In one embodiment of the present invention, neural networks designed for direct SOC estimation use one hidden layer and were trained with the backpropagation gradient decent learning algorithm using supervised learning. The backpropagation algorithm calculates the gradient of the error between the network output and target with respect to the network weights and then adjusts the weights in the direction of steepest decent. As the process is repeated over many epochs or iterations, the weights move towards a location of minimum output error. Network training is terminated when a stopping criterion such as a minimum error value or maximum number of training epochs is reached.

Preprocessing techniques similar to those discussed in the ARMA section proved to be effective for the neural network models as well. The features were passed through a lowpass Butterworth filter to remove high frequency noise from the model fitting routine. Then, the gradient of the features was taken with respect to time in order to take advantage of the fact that the features were similar in shape but often were offset in value. During the transient period directly after a load is applied to the battery, this gradient operation often produces signal spikes orders of magnitude larger than the average signal value. These large magnitude spikes are eliminated in the preprocessing by using a logarithm operation to compress the signals into a more compact range. Finally, the feature signals are normalized with respect to the maximum and average values of the training set features so that they fall in the range of −1 to +1 if transigmoidal transfer functions are used or from 0 to 1 for logsigmoidal functions. Smaller networks also tend to be better at generalization. For time-delay neural networks, the selection of the number of delays and the length of the delays is crucial to the performance of the networks. Both short and long delays were tried during different training runs. The short delays may give better performance, indicating that the battery SOC does not involve long time-constants.

Fuzzy Logic

Fuzzy logic models are well known in the mathematical and computing arts and will not be described further here. A neural network trainer can be used to construct a set of rules from available data collected from one or more batteries. Where a number of measurement signals were available (for example, 6), it was sometimes found advantageous to supply a sub-set of the available data within the feature vector to the fuzzy logic model, so as reduce the number of fuzzy rules generated by the neural trainer.

As will be clear to those skilled in the mathematical or computing arts, other predictive algorithms may be used instead of, in addition to, or otherwise in combination with one or more of the algorithms discussed above.

Decision Fusion

Decision fusion can be used to improve the quality of condition assessment and increase the confidence of the assessment. Algorithms are known in the art, but have not been previously used to determine battery condition parameters from the outputs of a plurality of predictive algorithms.

For example, SOC, SOH, and SOL estimates from three predictive algorithms provide three parallel estimates of each of these condition parameters. These estimates are fed into a decision fusion algorithm that determines how well the predictors compare, and has access to processed sensor data, previous history, and knowledge about the battery type. Using this information, the decision fusion algorithm provides a combined prediction of the condition parameter (SOC, SOH, or SOL) with a measure of confidence.

In one example, three SOC predictions were fed to the decision fusion algorithm; 85%, 83%, and 30%. The decision fusion algorithm also retrieved the SOC information from the previous cycle and battery type information. The algorithm then decided that the two SOC predictions, 85% and 83% are more likely to be correct than the other, not only because they agree with each other but because the previous cycle SOC was more similar to these estimates under the current operating conditions. The 30% SOC prediction is then de-weighted by the algorithm, a single SOC prediction is calculated, and a confidence is assigned to the new SOC estimate.

The decision fusion algorithm may also have access to the sensor signals that are fed to the SOC, SOH, and SOL predictors. In the example described above, a dead sensor signal may have caused the bad 30% SOC prediction. If the other two SOC estimators did not use the dead sensors signal, it is likely that this is the case and a flag could be raised as a result.

Implementation of the algorithms described above may be in the form of a software program executable by a processor within a device according to an embodiment of the present invention.

In other embodiments, the estimates provided by the predictive algorithms may be averaged, or combined according to predetermined weights, or combined using any convenient method.

Applications of Battery Diagnostic Systems and Methods

Embodiments of the present invention may be used in commercial markets such as automotive batteries, electric vehicle batteries, and backup power systems for communication, banking and computer networks, aircraft and sea vessel battery systems, small vehicle and equipment batteries found in forklifts, night vision goggles, and radios.

Fuel Cells

Embodiments of the present invention can be used with fuel cells. Fuel cells do not have to be monitored for SOC, but SOH (i.e. conversion efficiency) is an important issue for operational readiness and overall life.

The porous gas-diffusion electrodes of a fuel cell are under mixed control of electrode kinetics, mass transfer and ionic conduction; therefore, the rate-limiting process cannot be described in simple terms. Contact resistance and ohmic resistance are key parameters that depend strongly on the specific design and operating conditions of each cell. In situ impedance methods are very desirable to characterize the rate-limiting processes in fuel cells. AC impedance measurements may be useful for achieving such characterization.

The ionic resistance of a solid polymer electrolyte membrane can be studied using AC impedance. Also, dehydration of the membrane reduces the ionic conductivity and is itself affected by current passage. The diffusion of water in the membrane can be studied as well. The membrane resistance can be identified by means of an electric circuit model (similar to the Randles circuit for battery cells) with grain boundary resistance and capacitance representing a “membrane relaxation” process related to membrane dehydration, bulk membrane resistance, and contact resistance.

Modeling polymer electrolyte membrane fuel cell (PEMFC) electrode response can be achieved with a porous electrode model incorporating a transmission line network. The model assumes that part of the pore is covered with a thin film and part of it contacts a flooded agglomerate. PEMFC operate at high efficiencies when using pure hydrogen, but fail when using hydrogen obtained from hydrocarbon or methanol processing. This is due to electrode poisoning from CO entering the fuel cell. Adsorbed CO not only affects the reactivity of the accessible electrode surface by preventing H₂ adsorption by site exclusion, but also lowers the reactivity of the remaining uncovered sites through dipole interactions and electron captures. The amount of CO contamination can be observed using impedance measurements thus making it possible to established H₂ flushing control when the CO contamination gets too high (i.e. diminishing the cell efficiency).

Semi-fuel cells (such as aluminum/hydrogen peroxide semi-fuel cells) may be used for e.g. underwater electric vehicles. There are a number of health and efficiency related concerns with these types of cells that include:

1) the corrosion reaction of the aluminum in a caustic medium,

2) the direct reaction of the aluminum with hydrogen peroxide,

3) the parasitic homogeneous self-decomposition of the hydrogen peroxide, and

4) the heterogeneous decomposition of the hydrogen peroxide with substrate materials, such as the nickel substrate, silver catalyst or palladium/iridium catalyst.

Because of the overlapping physical electrochemical mechanism and similarities, embodiments of the present invention can be used to evaluate fuel cell systems, and hybrid systems including a fuel cell.

Condition-Based Maintenance Systems

Condition-Based Maintenance (CBM) is an emerging concept enabled by the evolution of key technologies such as: improved sensors, microprocessor capabilities, digital signal processing, simulation modeling, multi-sensor data fusion, and automated reasoning. CBM involves monitoring the health or status of a component or system and performing maintenance based on that observed health and predicted remaining useful life (RUL). The philosophy is in contrast to performing maintenance on a time/use basis or corrective maintenance based on the occurrence of a failure. The CBM approach, if successfully implemented, provides the promise of reduced life cycle maintenance costs, improved safety, and increased operational readiness.

Maintenance actions can be performed when a component or system fails (corrective), on an event or time basis (preventative), or when an assessment of condition indicates that a failure is likely (predictive). Corrective maintenance produces low maintenance cost (minimal preventative actions), but high performance costs caused by operational failures. Conversely, preventative maintenance practice produces low operations costs, however more preventative actions produce greater maintenance department costs. Moreover, the application of statistical safe-life methods (still preventative) usually leads to very conservative estimates of the probability of failure. The result of such methods is an additional hidden cost associated with disposing of components that still retain significant remaining useful life. Hence, a model-based predictive diagnostics system for primary and secondary batteries can form part of a condition-based management system.

Other Applications

Embodiments of the present invention can be used to evaluate other systems comprising a conducting component. One example is in machine maintenance, in particular in machine oil quality analysis. Machine oil is an ionic compound and will conduct electricity based on changes in concentration, additives, and contaminates such as water and debris. Applying the impedance measurement approach and diagnostics processing to oil quality can lead to improved machine maintenance.

Embodiments of the present invention can also be used to monitor the state of capacitive systems, such as supercapacitors, and hybrid systems including an electrochemical cell and a supercapacitor.

An apparatus for determining a condition parameter of a battery comprises electrical connections, providing electrical communication with the battery, the electrical connections receiving measurement signals correlated with the condition parameter of the battery; a processor; a memory; a clock; and a software program, executable by the processor, operable to pass input data determined from the measurement signals to a plurality of prediction algorithms, wherein each prediction algorithm provides a condition parameter estimate, wherein the condition parameter of the battery is determined from a plurality of condition parameter estimates provided by the prediction algorithms. The measurement signals can comprise an electrical signal correlated with the electrical impedance of the battery. The software program can be further operable to provide a decision fusion algorithm receiving the plurality of estimations of the condition parameter; wherein the condition parameter of the battery is provided by the decision fusion algorithm.

An apparatus to determine a condition parameter of an battery, wherein the condition parameter is the state of charge, state of health, or state of life of the battery, comprises electrical contacts, locatable so as to be in electrical communication with the battery; circuitry operable to provide an electrical excitation signal to the battery through the electrical contacts, to receive an electrical signal from the battery, and to determine electrical impedance data for the battery; a processor; a memory; and software, executable by the processor, operable to provide three predictive algorithms and a decision fusion algorithm, wherein the three prediction algorithms receive input data derived from the electric impedance data, the three prediction algorithms each provide an estimate of the condition parameter, so as to provide three estimates of the condition parameter to the decision fusion algorithm, wherein the condition parameter is determined by the decision fusion algorithm using the three estimates; and a display, whereby the condition parameter may be displayed to a user of the apparatus. The apparatus may further comprise a data input mechanism operable to receive identification data corresponding to the battery, wherein the prediction algorithms access information stored within the memory corresponding to batteries having the identification code.

Examples discussed are illustrative and are not intended to be limiting. Other embodiments of the present invention will be clear to those skilled in the arts. It will also be clear to those skilled in the arts that components of various alternative embodiments and examples can be combined in different ways, and that alternatives discussed in one example may be applied in other examples. The contents of U.S. patent application Ser. No. 10/360,023, filed Feb. 6, 2003, and U.S. Provisional Patent Application Ser. No. 60/358,544, filed Feb. 19, 2002, are incorporated herein by reference.

Having described our invention, we claim:

1-23. (canceled)

24. An apparatus for determining a condition parameter of a battery, comprising:
electrical connections, connectable so as to receive measurement signals related to the condition parameter;
a feature extraction processor, receiving the measurement signals and generating input data; and
a computer operable to provide the input data to a plurality of different prediction algorithms, each prediction algorithm providing a condition parameter estimate, so as to determine a plurality of condition parameter estimates, and
to provide the plurality of condition parameter estimates to a decision fusion algorithm, the decision fusion algorithm predicting the condition parameter from plurality of condition parameter estimates.

25. The apparatus of claim 1, wherein the plurality of different prediction algorithms includes an Auto-Regressive Moving Average (ARMA) algorithm.

26. The apparatus of claim 1, wherein the plurality of different prediction algorithms includes a neural network algorithm.

27. The apparatus of claim 1, wherein the plurality of different prediction algorithms includes a fuzzy logic algorithm.

28. The apparatus of claim 1, wherein the plurality of different prediction algorithms includes an Auto-Regressive Moving Average (ARMA) algorithm, a neural network algorithm, and a fuzzy logic algorithm.

29. The apparatus of claim 1, wherein the condition parameter is a state of charge.

30. The apparatus of claim 1, wherein the condition parameter is a state of health.

31. The apparatus of claim 1, wherein the condition parameter is a state of life.

32. The apparatus of claim 1, further comprising a data input for battery identification data, the battery identification data being provided to the decision fusion algorithm,
the decision fusion algorithm using the battery identification data in predicting the condition parameter.

33. The apparatus of claim 1, wherein the measurement signals are correlated with one or more of a group of battery parameters consisting of terminal voltage, charging current, ambient temperature, case temperature, surface temperature, internal temperature, electrolyte pH, and electrical impedance.

34. The apparatus of claim 1, wherein the measurement signals include a current waveform signal induced by electrical excitation of the battery,
the input data including impedance values determined from the current waveform signal.

35. The apparatus of claim 11, wherein the impedance values are determined over
a frequency range of approximately 10 Hz-10 kHz.

37. The apparatus of claim 11, wherein the feature extraction processor further uses a simulating annealing algorithm to determine electrochemical model parameters from the impedance values,
the electrochemical model parameters being provided to the plurality of different prediction algorithms.

38. The apparatus of claim 1, further comprising a user interface, the condition parameter being displayed on the user interface.

39. The apparatus of claim 1, wherein the feature extraction processor is provided by the computer.

40. An apparatus for determining a condition parameter of a battery, comprising:
electrical connections for receiving measurement signals related to one or more battery parameters;
a feature extraction processor, receiving the measurement signals and generating input data, the input data including electrical impedance values;
a computer, executing software operable to provide the input data to a plurality of different prediction algorithms, each prediction algorithm providing a condition parameter estimate, so as to determine a plurality of condition parameter estimates, and to provide the plurality of condition parameter estimates to a decision fusion algorithm, the decision fusion algorithm predicting the condition parameter from plurality of condition parameter estimates; and
a user interface, the condition para meter being visually represented on the user interface.

41. The apparatus of claim 16, wherein the condition parameter is a state of charge, a state of health, or a state of life.

42. The apparatus of claim 16, wherein the feature extraction processor is further operable to determine electrochemical model parameters for the battery from the impedance values, the electrochemical model parameters being provided to the plurality of different prediction algorithms.

43. The apparatus of claim 16, wherein the plurality of different prediction algorithms includes an Auto-Regressive Moving Average (ARMA) algorithm, a neural network algorithm, and a fuzzy logic algorithm.
